(19) United States
(12) Patent Application Publication
(10) Pub. No.: US 2016/0120208 A1
(43) Pub. Date: May 5, 2016

(54) Apparatus and Method for Coring and Stuffing a Banana

(71) Applicant: Richard Henry Pico, Bend, OR (US)

(72) Inventor: Richard Henry Pico, Bend, OR (US)

(21) Appl. No.: 14/531,914

(22) Filed: Nov. 3, 2014

(51) Int. Cl. A23L 1/212; A23P 1/08

(52) U.S. Cl. CPC A23L 1/2125; A23P 1/087

(57) ABSTRACT

The method and apparatus for coring, filling or stuffing a banana. The apparatus is comprised of a banana cradle that has a base, a trough on one side of the base, a collar attached to the base situated at one end of the trough, a strapping apparatus attached to the base on the other opposite end of the trough from the collar, and a coring device to remove a banana plug from the banana. The trough is sized and shaped to accept an unpeeled banana. The end of the unpeeled banana is cut off. A coring device is used to remove a plug from the interior of the banana. Once the plug of the banana is removed a filling apparatus is used to fill the internals of the cored banana with one or more of the complimentary food items with bananas.

### CROSS REFERENCE TO RELATED APPLICATIONS

a. None

### BACKGROUND OF THE INVENTION

The present invention is a method and device for filling or stuffing the internals of a banana with various food products such as peanut butter, creams, ice cream, chocolate and other foods that are complimentary with bananas. There is a wide variety of items that can compliment a banana and it is not the intent of the inventor to list all possible fillers that can be used to stuff a banana.

Presently, bananas are often times cut or chopped and added to various foods such as ice cream, cereal or other foods that complimented with bananas. Bananas that are paired with other foods have typically been served as mentioned above or the food is processed to add the flavor of the banana in the cooking process, such as foods like banana bread, or banana shakes. The banana is blended within the food that is served.

Fresh bananas that are removed from their peel have a distinctive taste and quality that many people prefer. It has been observed by the inventor that coupling the taste of a freshly peeled banana with complimentary foods would provide the consumer with an alternative to the various alternatives for adding bananas to various other foods, such as cereal, bread, chocolate, peanut butter, ice cream or other complimentary foods. Typically bananas are sliced or chopped and added to the various other food items. This type of adding foods with bananas requires various utensils, kitchen ware and dishes to prepare and serve.

One of the benefits of serving a banana is the ease in which it can be served. Bananas are already pre-packaged in that a banana has a peel that can be easily removed. If one needs a snack at a later time, a banana can be packed or stored and readily available to consume. A fresh banana can be eaten without the need of any utensils. One simply has to peel the banana and consume the banana. Those who like to mix their banana with a complimentary food item sometimes find it difficult to mix a fresh banana with the complimentary food item. If the banana is a snack and the complimentary food item is brought with the banana, the consumer of the banana will have to find a means for mixing the banana with the complimentary food item. If kitchen utensils such as a knife or fork and dishes, such as bowls or plates are not available, then the consumer will end up eating the banana and the complimentary food separately. Without utensils, consumers have been known to make a mess when trying to mix the banana with the complimentary food item. For example, it is not unusual for a freshly peeled banana to be dipped into a jar or peanut butter or other spreadable complimentary food.

There is a need to provide a snack of a freshly peeled banana with a complimentary food item. It has been observed by the inventor that a method and process for adding a complimentary food item with a banana would be beneficial if the banana can be peeled and eaten with the complimentary food item added to the banana. There is a long felt need for a freshly peeled banana that has the complimentary food already within the banana.

There is a need for being able to add a complimentary food item with a freshly peeled banana that allows the banana and complimentary food to be consumed at the same time and without the need for using dishes or utensils for consuming the banana and complimentary food item.

### BRIEF SUMMARY OF THE INVENTION

The method and apparatus for coring, filling or stuffing a banana. The apparatus for coring and stuffing a banana is comprised of a banana cradle that has a base, a trough on one side of the base, a collar situated at one end of the trough, a strapping apparatus on the other opposite end of the trough from the collar, and a coring device to remove a banana plug from the banana. The trough is sized and shaped to accept an unpeeled banana. When the unpeeled banana is placed onto the trough the stem is placed such that the stem sticks out of the collar and the unpeeled banana is resting on the trough. A strap from the strapping apparatus is placed over the end of the banana opposite the stem. Due to the natural curvature of the banana when the strap is tightened over the banana, the banana is straightened out conforming to the trough. The end of the unpeeled banana is cut off; the cut is made perpendicular to the length of the banana, exposing one end of the banana. A coring device is used to remove a plug from the interior of the banana. The coring device is a tubular device with two open ends. One end has a tab cut and folded into the interior of the tubular end approximately 90 degrees from the surface of the tubular wall. This tab is inserted into the end of the banana and pushed to the end of the banana; the coring device is turned or rotated such that the tab cuts the banana at the end allowing the banana core or plug to be more easily removed. After the coring device has been inserted and turned, the coring device is removed and a plug of internal banana is removed as well. Once the plug of the banana is removed a filling apparatus is used to fill the internals of the cored banana with one or more of the complimentary food items with bananas.

The filling apparatus typically consists of a squeezable container with a narrow outlet that can be inserted within the open end of the banana. A complimentary food item is placed within the filling apparatus. Since the banana is securely held within the trough of the banana cradle, an operator inserts the narrow opening of the filling apparatus into the open end of the exposed banana and the filling apparatus is squeezed or the filling material is pushed into the core of the banana. Once the banana's core is filled with the one or more complimentary food items, the strap is loosened or removed and the banana is removed from the banana cradle. The unpeeled banana is ready to be peeled and eaten right there or can be packed stored until later.

### BRIEF DESCRIPTION OF SEVERAL VIEWS OF THE DRAWING

FIG. 1: is a perspective view of the banana cradle.

FIG. 2 is an end view of the banana cradle with the collar end showing where the exposed banana end is situated when being used.

FIG. 3 is a side view of the banana cradle.

FIG. 4 is a side perspective view of a banana coring device.

FIG. 4a is an end view of the banana coring device.

### DETAILED DESCRIPTION OF THE INVENTION

Various embodiments of the methods and apparatus will now be described. The following descriptions provide specific details for a thorough understanding and enabling description of these embodiments. It should be noted, however, that the above “Background” describes technologies that may enable aspects and embodiments of the invention. One skilled in the relevant arts will understand, however, that the invention may be practiced without many of these details. Additionally, some well-known structures or functions may not be shown or described in detail, so as to avoid unnecessarily obscuring the relevant description of the various aspects and embodiments of the invention.

The terminology used in the description presented below is intended to be interpreted in its broadest reasonable manner, even though it is being used in conjunction with a detailed description of certain specific embodiments of the invention. Certain terms may even be emphasized herein; however, any terminology intended to be interpreted in any restricted manner will be overly and specifically defined as such in this Detailed Description section.

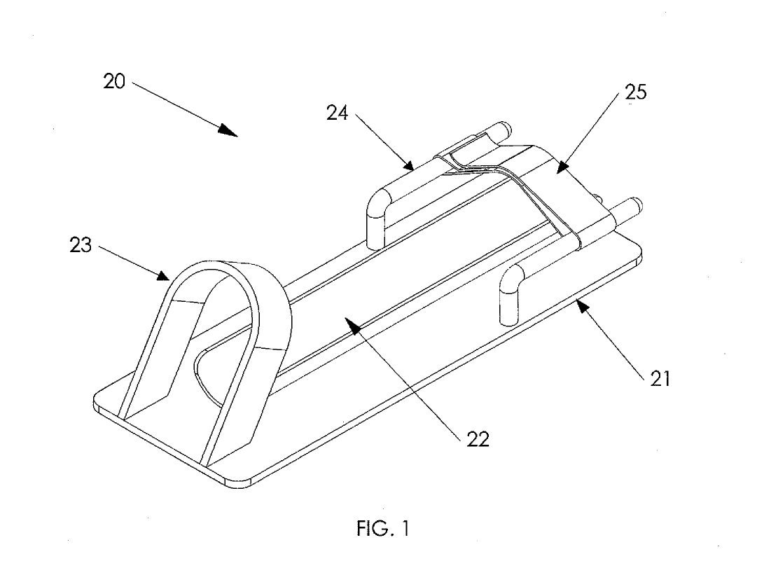

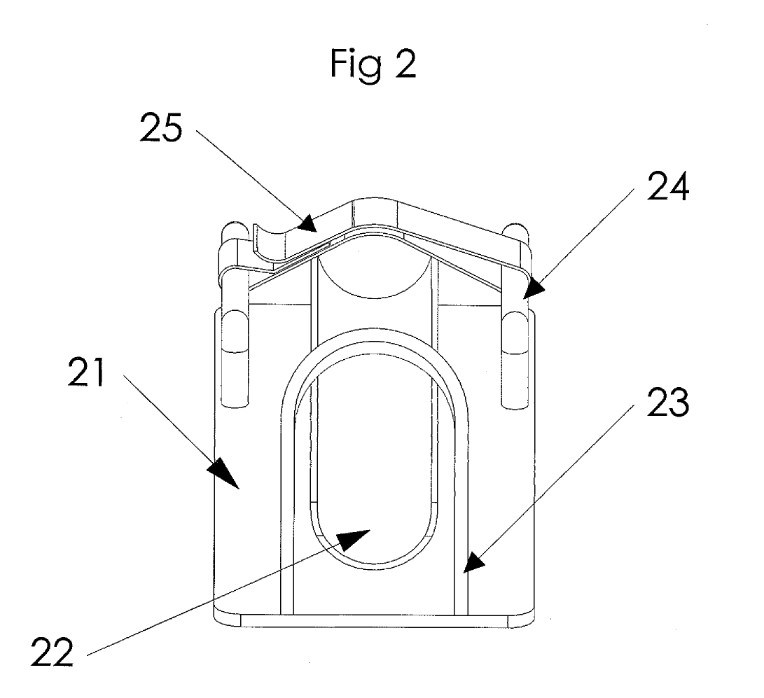

From FIG. 1, the apparatus for coring and filling or stuffing a banana comprises a banana cradle 20 that has a base 21, a trough 22 attached to one side of the base, a collar 23 attached to the base 20 and is situated at one end of the trough 22, and a strapping apparatus on the other end of the trough.

The strapping apparatus consists of a strapping support arms 24 attached to the base 21 and a strap 25. The strap is one which fits over the strap arms and is able to be tightened over an object placed in the trough. There are various types of straps and strapping devices that can be used and FIG. 1 is just one example of a strapping apparatus that can be used.

The base of the banana cradle is sized and shaped such that the banana cradle can either be secured to a kitchen surface such as a table or countertop. The size of the banana cradle allows for the apparatus to be portable and easily transported. Having a device that is portable allows for the device to be used at picnics and other outdoor events.

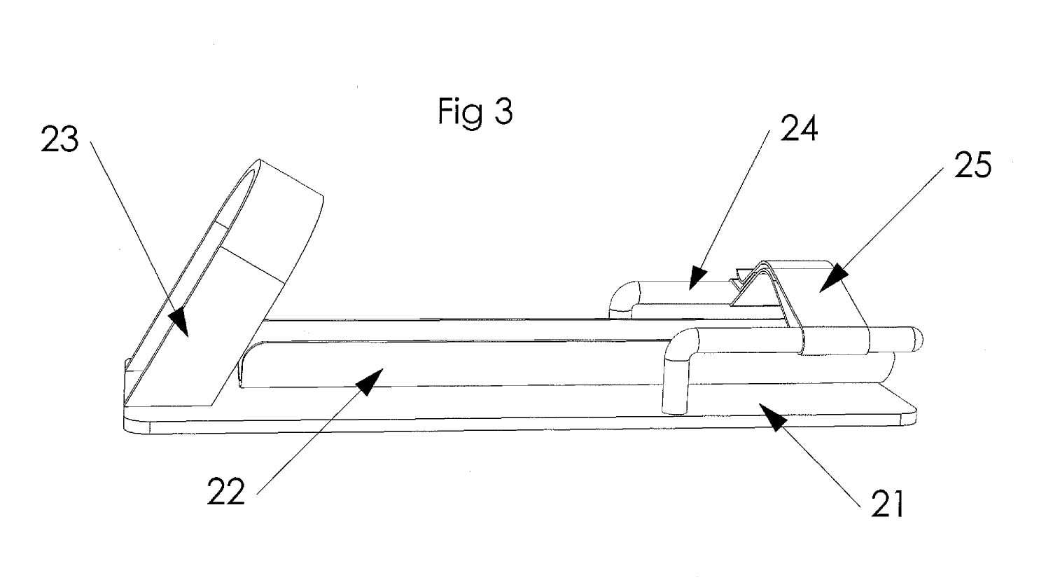

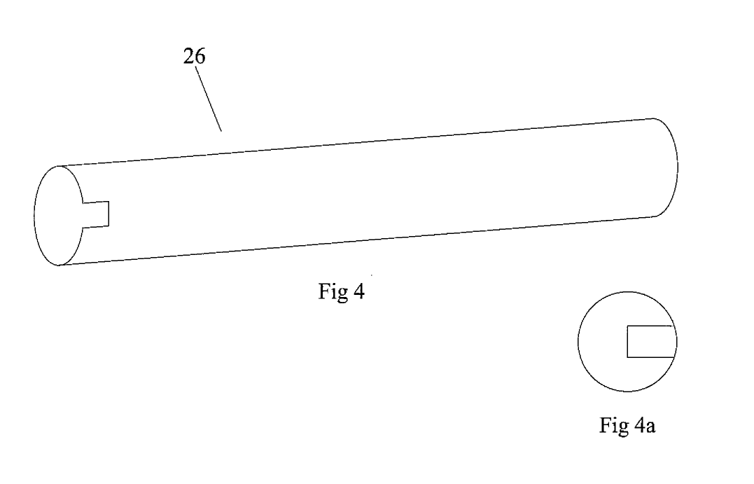

The trough 22 that is attached to the base is a cradle like piece that is sized and shaped to accept a banana, see FIG. 3. The stem of the banana—the stem having been previously connected to the stalk—is placed through the collar 23 such that the banana is able to sit in the trough 22 and the stem is sticking out of the collar. With the banana in the trough and the stem sticking out the end of the collar, the strap 25 is placed over the other end of the banana at the other end of the trough. The strap is tightened and when this is done the banana is straightened out. Normally bananas are curved, with the collar holding down the end of the banana with the stem and the strap tightened over the other end, the banana is straightened out in the trough. The end opposite the stem end is then cut, exposing the end of the banana. The end of the exposed banana is somewhat circular and a coring device, 26, FIG. 4 is then inserted into the end of the banana such that the coring device goes down the length of the banana.

The coring device 26 is a straight tubular device with an open end that is inserted into the exposed end of the banana. The open end of the coring device that is inserted into the banana end has a folded over tab 27. Once the tab or the end of the coring device reaches the end of the banana, the coring device is rotated and the end of the banana is detached from the banana. As the coring device is withdrawn from the banana, the banana core is removed from the banana leaving a tubular void in the banana for stuffing material.

The coring device can be inserted the entire length of the banana or partially down the banana. For best stuffing of the banana, the coring device should go the entire length of the banana, approximately one half inch from the stem end of the banana.

Once the internal plug of the banana is removed a filling apparatus, not shown, is used to fill the internals of the cored banana with one or more of the complimentary food items with bananas. The filling apparatus typically consists of a squeezable container with a narrow outlet that can be inserted within the open end of the banana. A complimentary food item is placed with the filling apparatus. Since the banana is securely held within the trough of the banana cradle, the operator inserts the narrow opening of the filling apparatus into the open end of the exposed banana and the filling apparatus is squeezed or the filling material is pushed into the core of the banana. Once the banana's core is filled with the one or more complimentary food items, the strap is loosened or removed and the banana is removed from the banana cradle. The unpeeled banana is ready to be peeled and eaten right there or can be packed stored until later.

Another aspect of the banana filling process is the making of an internal banana plug that can be consumed. It has been noted by the inventor that taking the banana plug and covering or dipping said plug into a complimentary food item, such as chocolate, makes for a delicious snack. The applicant finds that after covering the plug with a complimentary food item it is best to place the food item on a non-stick surface and place in a freezer for a short period of time. This produces a readily eatable banana plug covered in a complimentary food item that is easy to consume. With the item frozen, any liquid or semi-liquid complimentary food item is frozen and not prone to mess up the consumer's hands or self.

1. A banana stuffing apparatus comprised of:
a banana cradle that has a base, a trough, a hold down collar, a strapping apparatus with the trough attached to one side of the base, the hold down collar attached to the base on the same side as the trough and situated at one end of the trough, the strapping apparatus at the other end of the trough in which the size, shape and placement of the trough with the hold down collar and strapping apparatus allow a user to place an unpeeled banana through the collar such that the stem of the banana is sticking out the end of the collar and the banana is resting in the trough so that when the strap is adjusted and tightened over the other end of the banana this causes the banana to become straighter and allows the end of the banana that is exposed at the strap end to be cut perpendicular to the length of the banana exposing the banana end;
a coring device, consisting of an open tube with a folded tab at one end of the tube, wherein the end with the folded tab is inserted into the exposed banana and inserted down the length of the banana allowing for the tube to be rotated to detach a banana plug from the banana with then said banana plug removed from the banana as the coring device is removed from the banana leaving a void in the banana; and a filling apparatus that is filled with one or more complimentary food items that has a narrow outlet to allow insertion into a void at the end of the banana, produced when the plug of internal banana is removed from the banana, the filling apparatus then injecting the complimentary food item into the void where the banana plug was removed from the banana.

2. A method for stuffing a banana, the steps including:
Attaching a trough to a base with the trough sized and shaped to accept an unpeeled banana;
Attaching a collar to the base over one end of the trough, with the collar sized and shaped to allow the stem of an unpeeled banana to be inserted through the collar;
Attaching a strapping device to the base at the end of the trough opposite the collar;
Inserting a stem of an unpeeled banana through the collar such that the unpeeled banana is able to sit in the trough with the end opposite the stem sticking out the other end of the trough;
Placing the straps over the end of the unpeeled banana;
Tightening down the straps over the unpeeled banana causing the banana to conform to the shape of the trough;
Making a perpendicular cut of the banana end that is sticking out of the trough at the opposite end from the stem;
Inserting a hollow tubular coring device down the length of the unpeeled banana with the end of the tube being inserted having a tab cut and folded into the center of the tube;
Rotating the coring device;
Removing the coring device from the unpeeled banana and removing a banana plug from the core of the banana and leaving a void in the unpeeled banana;
Filling the void with a complimentary food item;
Loosening the strap; and
Removing the banana from the trough.
